(19) United States
(12) Patent Application Publication
(10) Pub. No.: US 2010/0116192 A1
(43) Pub. Date: May 13, 2010

(54) BREAK APART MODULAR ATV FLAG AND COUPLER

(76) Inventors: Chuck Avery, Vancouver, WA (US); Lynn Avery, Vancouver, WA (US); William S. Scott, Vancouver, WA (US)

Correspondence Address: RYLANDER & ASSOCIATES PC, P.O. Box 250, VANCOUVER, WA, 98660, US

(21) Appl. No.: 12/572,193

(22) Filed: Oct. 1, 2009

Related U.S. Application Data
(60) Provisional application No. 61/102,426, filed on Oct. 3, 2008.

(51) Int. Cl. G09F 17/00

(52) U.S. Cl. 116/173; 116/28 R

(57) ABSTRACT

A break apart modular flag and coupler for an ATV, includes a plurality of shaft segments, a plurality of break away couplers corresponding to said shaft segments coupling said plurality of shaft segments, a break away base coupler removably joining said one of said plurality of shaft segments to an ATV, and a flag attached to one of said plurality of shaft segments.

### CROSS-REFERENCE TO RELATED APPLICATIONS

The present application claims priority to co-pending U.S. Provisional Application Ser. No. 61/102,426, filed 3 Oct. 2008, which is hereby incorporated by reference into the present application.

### FIELD OF THE INVENTION

The present invention relates to modular flag systems for vehicles.

### BACKGROUND

All-Terrain Vehicle (ATV) enthusiasts are required by law to operate their vehicles in a safe, responsible manner. A specific legal requirement is that all ATVs must operate only when displaying an easily recognizable pennant attached to a pole and elevated approximately ten feet into the air. Products presently on the market aid operators in meeting all the legal requirements regarding the safety pennant, but the pole and associated components are easily broken while in use. Such damage is normally realized while far away from base vehicles. This means tools with which to make necessary repairs are not readily available. Once the safety pennant pole is damaged, operators can no longer safely use the vehicle, nor comply with legal safety regulations. This exposes operators to physical danger from other ATVs operating near them, and severe fines when apprehended by law enforcement officials.

Thus, there is a need for an ATV flag system that can be broken apart and replaced on site. There is a need for a flag system that is modular and will not break under stress from bushes and trees. There is a need for a flag system that is easy to put together and take apart. There is a need for a flag system that can be easily repaired in the field if it breaks apart under pressure from bushes and trees. There is a need for a flag system that allows the operator to meet the safety and legal requirements for ATV visibility. There is a need for a flag system designed for easy assembly by hand, and requires no tools.

### SUMMARY AND ADVANTAGES

A break apart modular ATV flag and coupler apparatus for ATVs of the present invention includes first and second shaft segments; a break away coupler breakably joining said first and second replaceable shaft segments; a flag on said first replaceable shaft segment; and, a break away base coupler removably joining said second shaft segment to an ATV.

A break apart modular flag and coupler for an ATV, includes a plurality of replaceable shaft segments; a force responsive break apart coupler disengageably joining said replaceable shaft segments in response to shaft applied pressure; a flag attachable to an end of one of said replaceable shaft segments; and, a break away base coupler joining one of said replaceable shaft segments to an ATV.

A break apart modular flag and coupler for an ATV, includes a plurality of shaft segments; a plurality of break away couplers corresponding to said shaft segments coupling said plurality of shaft segments; a break away base coupler removably joining said one of said plurality of shaft segments to an ATV; and a flag attached to one of said plurality of shaft segments.

A break apart modular flag and coupler for an ATV includes a plurality of shaft segments, each of said shaft segments having a first and a second end; a plurality of shaft couplers corresponding to said plurality of shaft segments, each of said shaft couplers having a first and a second interior coupler passages for receiving a shaft segment end, an interior cushion separating said first and second coupler passages, first and second coupler channels disposed at opposing ends of said shaft couplers, each of said coupler channels further including opposing apertures open to the interior of said shaft couplers, and a flexible retaining band disposed within each of said coupler channels; and, a removable base coupler having an interior coupler passage and removable connection means for connecting said base coupler to an ATV; wherein, said shaft segment ends are gripped by said flexible retaining bands through said apertures when said shaft segment ends are inserted into said coupler passages.

The break apart modular ATV and coupler of the present invention presents numerous advantages, including: (1) it be broken apart and replaced on site; (2) it is modular; (3) it easy to put together, take apart; (4) it breaks away systematically under pressure from bushes and trees and can be easily put back together; (5) it allows the operator to meet all safety and legal requirements for ATV operation; (6) it is designed for easy assembly by hand, and requires no tools; (7) it is design such that if damaged, it may be immediately repaired by the ATV operator, precluding an unsafe return to base for repairs.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an embodiment of Applicant's break apart modular ATV flag and coupler.

FIG. 2 shows and exploded view of Applicant's break apart modular ATV flag and coupler.

FIG. 3 shows a perspective view of Applicant's coupler.

FIG. 4 shows a cross-sectional view of Applicant's coupler.

### REFERENCE NUMBERS USED IN DRAWINGS

The following list of reference numbers used in the Drawings is provided for convenience:
10 Break apart modular ATV flag and coupler
20 Coupler
22 O-ring
24 Coupler wall
26 Coupler channel
27 Coupler side apertures
28 Coupler Inside passage
29 Coupler interior cushion
30 Shaft segment
40 Base coupler
50 Flag
ATV All Terrain Vehicle

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

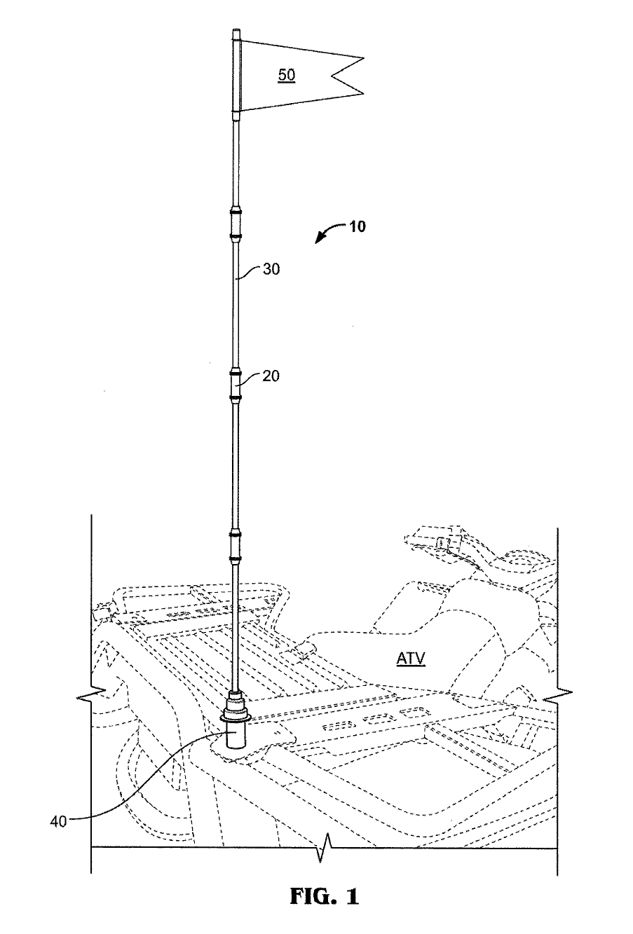

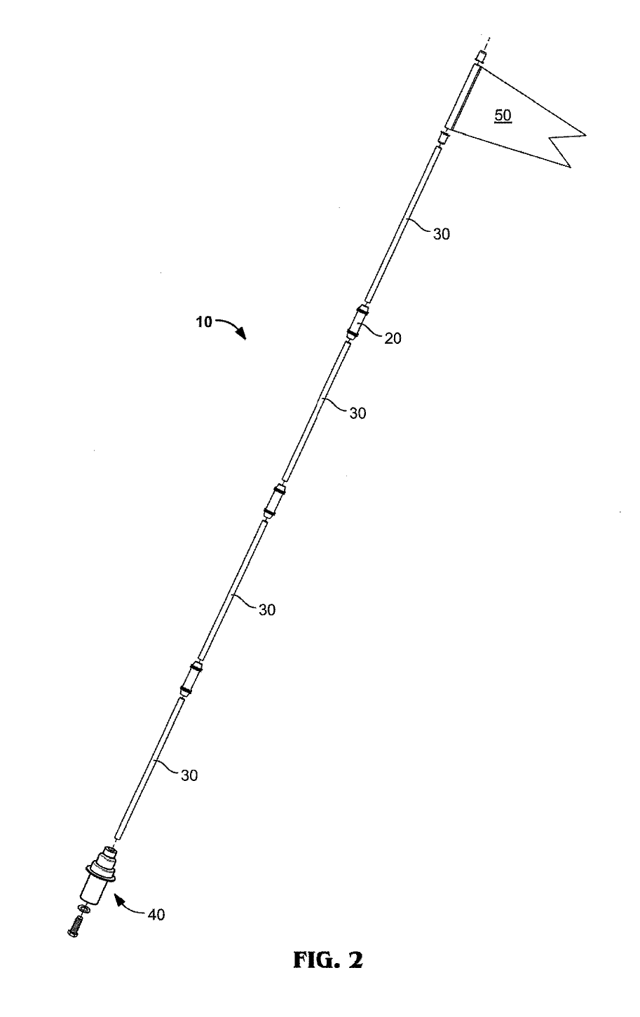

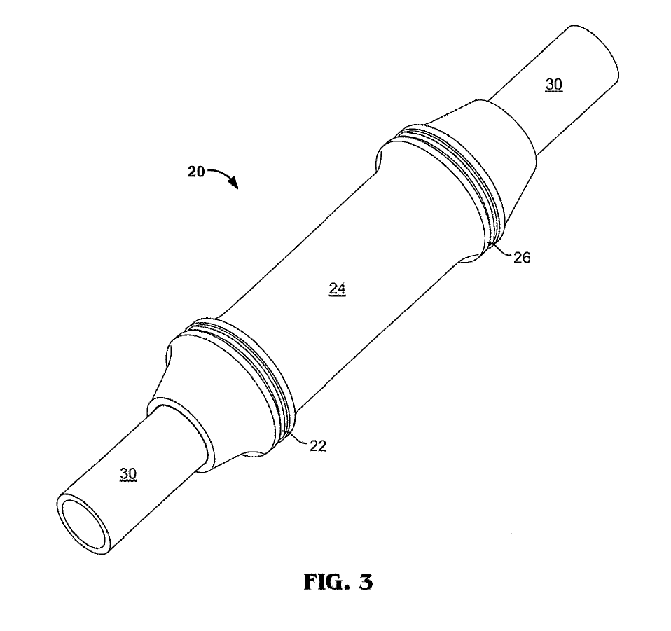

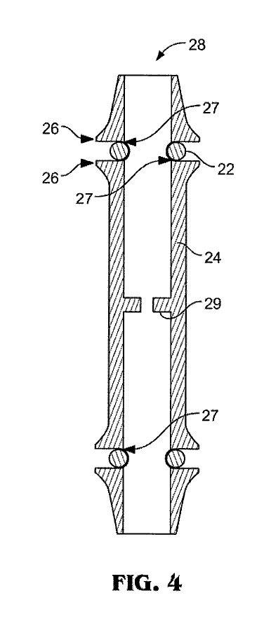

Applicant presents a break apart modular ATV flag and coupler having at least one break away coupler breakably joining first and second shaft segments, said first shaft segment supporting a flag on an end distal from said coupler, and a base coupler joining said second shaft segment to and ATV. As shown in FIGS. 1-4, break apart modular ATV flag and coupler 10 includes two or more shaft segments 30, one or more couplers 20 coupling shaft segments, a removable base coupler 20 coupling a shaft segment 30 to an ATV, a flag 50 attached to a shaft segment 30.

Couplers 20 are preferably hollow rubber tubes having an exterior wall 24 and an interior passage 28, with transverse O-ring grooves 26, each groove 26, having a side apertures 27 exposing the shaft segment 30 to the O-ring 22 allowing an O-ring 22 placed around said groove 26 to directly contact and grip a shaft segment 30 inserted in the tube 20 through the interior passage 28. Couplers are preferably provided with an interior cushion 29 with an opening, spacing the shaft segments 30 apart when inserted

In operation in one embodiment, the modular nature of the break apart modular ATV flag and coupler 10 shows its superior advantage. The rider attaches the base coupler 40 to the ATV using screws and nuts. A shaft segment 30 is then connected to the base coupler 40. A number of shaft segments 30 and couplers 20 are attached in series and finally a flag 50 is attached to a shaft segment at the distal end of the chain from the base coupler 40. The assembly can easily be stored in its taken apart state in a convenient carrying bag. When riding, if the ATV goes under a low hanging tree limb sufficient to break the strength of a shaft segment 30, the shaft segment 30 disengages from a coupler 20, or the series from the base coupler 40, at the point of most pressure. The rider can then reattach the shaft segments 30 and couplers 20 and ride away with a restored ATV flag. Absent this modular break away invention, a simple long flag would break and their would be no way of fixing it without complete replacement, which is not possible on the trail.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A break apart modular flag and coupler for an ATV, comprising:
first and second shaft segments;
a break away coupler breakably joining said first and second replaceable shaft segments;
a flag on said first replaceable shaft segment; and
a break away base coupler removably joining said second shaft segment to an ATV.

2. A break apart modular flag and coupler for an ATV, comprising:
a plurality of replaceable shaft segments;
a force responsive break apart coupler disengageably joining said replaceable shaft segments in response to shaft applied pressure;
a flag attachable to an end of one of said replaceable shaft segments; and
a break away base coupler joining one of said replaceable shaft segments to an ATV.

3. A break apart modular flag and coupler for an ATV, comprising:
a plurality of shaft segments;
a plurality of break away couplers corresponding to said shaft segments coupling said plurality of shaft segments;
a break away base coupler removably joining said one of said plurality of shaft segments to an ATV; and
a flag attached to one of said plurality of shaft segments shaft.

4. A break apart modular flag and coupler for an ATV, comprising:
a plurality of shaft segments, each of said shaft segments having a first and a second end;
a plurality of shaft couplers corresponding to said plurality of shaft segments, each of said shaft couplers having a first and a second interior coupler passages for receiving a shaft segment end, an interior cushion separating said first and second coupler passages, first and second coupler channels disposed at opposing ends of said shaft couplers, each of said coupler channels further including opposing apertures open to the interior of said shaft couplers, and a flexible retaining band disposed within each of said coupler channels; and
a removable base coupler having an interior coupler passage and removable connection means for connecting said base coupler to an ATV;
wherein, said shaft segment ends are gripped by said flexible retaining bands through said apertures when said shaft segment ends are inserted into said coupler passages.
